(19) United States
(12) Patent Application Publication
(10) Pub. No.: US 2006/0186865 A1
(43) Pub. Date: Aug. 24, 2006

(54) Voltage regulator

(75) Inventors: Michele La Placa, Cefalu (IT); Ignazio Martines, Tremestieri Etneo (IT); Michelangelo Pisasale, Catania (IT)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics S.r.l., Agrate Brianza (MI) (IT)

(21) Appl. No.: 11/349,576

(22) Filed: Feb. 8, 2006

(30) Foreign Application Priority Data
Feb. 11, 2005 (IT) VA2005A000009

(51) Int. Cl. G05F 1/56; G05F 1/40

(52) U.S. Cl. 323/273

(57) ABSTRACT

A voltage regulator may include an output stage controlled by a control voltage determined as a function of the difference between a reference voltage and a signal representing an output voltage of the regulator generating the output voltage on an output node of the regulator. An auxiliary stage may be connected in parallel to the output stage and cooperate therewith in supplying a load connected to the regulator. A sensing resistance may be connected in series with the output stage, and an voltage drop amplifier may be connected to the sensing resistance to generate a second control voltage of the auxiliary stage.

### FIELD OF THE INVENTION

This invention relates to voltage regulators and, more particularly, to a high efficiency voltage regulator with reduced silicon area occupation that is particularly suitable for FLASH memory devices having a NOR-type architecture.

### BACKGROUND OF THE INVENTION

The electronic device market demands fast devices having smaller and smaller sizes with reduced power consumption. Some electronic devices require a lower supply voltage than is typically used in CMOS technology to help prevent jeopardizing reliability of the devices. Typical 0.13 μm CMOS fabrication technologies for nonvolatile memory devices produce fast high density memory chips that operate at a relatively low supply voltage (1.8V), but the widespread use of systems and interfaces operating at 3.3V has slowed down the transition towards devices that are supplied at 1.8V.

As a marketing solution, a DC-DC converter may be used for converting an externally available supply voltage of 3.3V to a supply voltage of 1.8V, as required by a typical FLASH memory device. FIGS. 1A and 1B illustrate two prior art architectures of voltage regulators that are used for this purpose. The illustrated voltage regulators illustratively include an amplifying stage that compares a scaled replica of the output voltage with a reference voltage VBG. These amplifiers generate a control voltage VREF of a MOSFET that is set in a more or less deep conduction state depending on whether the voltage on the load LOAD decreases or increases.

The illustrated converter architectures are characterized by a negative feedback loop that includes the output stage. The inclusion of the output stage requires the implementation of a relatively onerous compensation for obtaining an adequate frequency stability range, penalizing the response speed. This leads to a relatively low stability of the output voltage in the presence of fast variations of the load current. The response speed of the feedback loop is also sacrificed to fulfill stand-by power consumption requisites and, during normal operation, to not significantly increase the overall power consumption of the system with respect to the power consumption of a typical 3.3V “stand alone” memory device.

As such, the above-noted regulators are unsuitable for a NOR-type FLASH memory which is characterized by relatively impulsive absorbed currents. Moreover, the response lag time when resuming from a stand-by state could penalize the speed for accessing the stored data.

Another prior art regulator disclosed in an article by den Besten et al. entitled “Embedded 5V to 3.3V Voltage Regulator for Supplying Digital IC's in 3.3V CMOS Technology,” IEEE JSSC, Vol. 33 No. 7, July 1998 is illustrated in FIG. 2. For clarity of illustration, the pre-charge and protection circuits (of the low-voltage transistors), which are enabled during turn on phases of the device, have been omitted. The regulator illustratively includes an amplifier that generates a control voltage VREF of a MOSFET as a function of the difference between a reference voltage VBG (which is relatively insensitive to process spread, supply and temperature variations) and a voltage proportional to the output voltage KVBG. The output stage remains excluded from the feedback loop, and this improves the frequency stability and the response speed.

The regulator uses a stage M2 for replicating the output voltage VOUT on the source terminal of the transistor M2 to ensure stability of the output voltage VOUT independently from the current delivered to the load LOAD. The MOS M2 of the replicating stage and the MOS M4 of the output stage are matched for compensating eventual process spread and temperature variations, and controlling the output voltage VOUT at a desired value KVBG=VBG*(1+R2/R1).

As such, the control of the DC component of the output voltage is relatively slow but accurate. Therefore, the operational amplifier that generates the control voltage VREF may be biased with currents in the order of microamperes with a negligible impact on the overall stand-by consumption of the sub-system, which includes the memory and the DC-DC converter.

The regulator further includes an auxiliary cascode stage including the MOSFET M8 which is controlled by the same VREF voltage that controls the output stage M4. This auxiliary stage is activated by closing the switch M9, and it cooperates with the output stage M4 to deliver the required current to the load. When the load is in a stand-by state, the auxiliary cascode stage M8 is turned off, the switch M9 is open, and the stand-by current is delivered to the load only through the output stage M4. The switch M9 is controlled by a control circuit that includes the block ELEVATOR and the logic NOT gate. The control circuit generates an enable/disable command EN_N for the switch M9 as a function of an external command STBY_N for setting the regulator in a stand-by state.

Typically, the transistor M8 is much larger than the transistor M2 (or M4) because the current absorbed during a normal functioning condition is much larger than the current absorbed in a stand-by state. The capacitor C1 has a large capacitance to reduce noise on the control node of the output stage M4, since it is coupled to the gate-source capacitance of the cascode transistor M8.

The output impedance is relatively low, as is typically the case in common drain stages, and the filter capacitor CF allows spikes of the load current to be sustained, thus reducing the ripple of the output voltage. The transistors M2, M4 and M8 are N-channel low voltage natural MOSFETs, i.e., MOSFETs with a relatively low threshold voltage and thin oxide layers. These transistors are preferred when a broad functioning range is required for a supply voltage of 2.4V and if the control voltage VREF is not boosted. With this type of transistors, the auxiliary stage M8 can be smaller than in the case an enhancement transistor having higher threshold is chosen.

The resistor R3 sets the working point of the auxiliary transistor M8 over the initial level of the drain current Id/gate-source voltage (Vgs) trans-characteristic, in the most linear portion of the trans-characteristic that also has the steepest slope. This limits variations of the output voltage when the delivered current varies, and thus reduces ripple. Depending on the size of the transistor M8, its bias current in a conduction state is on the order of one milliampere. In a stand-by state, the current path toward ground is interrupted by turning off the transistor M10.

The circuit illustrated in FIG. 2 is burdened by several drawbacks. A first drawback is due to the functioning of the power transistor M8 with a constant gate voltage. An average deliverable current of several tenths of milliamperes is typically required, with an external supply at the allowable minimum level. Moreover, there are stringent specifications on the maximum variation of the average output current, e.g., smaller than ±5% of the nominal value. As such, this may require the use of a relatively large transistor M8 (e.g., channel width larger than 5000 μm).

A second drawback is that the transistor M9 is connected in series with the transistor M8. The same current flowing in the transistor M8 also flows in the transistor M9 which is a high-voltage transistor, meaning it has a relatively thick oxide layer for withstanding the entire supply voltage. In general, this is larger than the maximum voltage the low-voltage transistors may withstand. The transistor M9 is also oversized to avoid relevant voltage drops that may negatively affect the control of the voltage VOUT, especially when the external voltage is at the minimum level of the allowable supply range. In most cases, the channel width of the transistor M9 is more or less similar to that of the transistor M8 and occupies a significant silicon area.

A further drawback results from the presence of the leakage path (leaker) formed by the resistor R3 and the transistor M10. The “leaker” that is essential for biasing the stage M8 during a normal operating condition may significantly worsen overall consumption with respect to the typical consumption of a classic 3.3V memory device.

### SUMMARY OF THE INVENTION

A voltage regulator is provided which requires less silicon integration area and has less power consumption than the above-described prior art devices while still retaining desired effectiveness. The auxiliary stage of the regulator that cooperates with the output stage for supplying the load is not controlled by the same control voltage of the output stage, but instead with a voltage that depends on the current that flows in the latter.

More particularly, a sensing resistor may be electrically connected in series to the output stage. The voltage drop thereon may be amplified by a voltage amplifier that generates the control voltage of the auxiliary stage. Therefore, the auxiliary stage is biased in a deeper or less deep conduction state when the current flowing through the output stage increases (diminishes). As a result, a “leaker” is no longer required for biasing the auxiliary stage and it is thus possible to reduce its size while keeping the output voltage substantially constant. Moreover, the auxiliary stage may be turned off by the amplifier, thus a switch in series therewith is no longer necessary when the regulator is in a stand-by state. The voltage amplifier of the regulator may be connected such that the current absorbed by it also flows through the load.

### BRIEF DESCRIPTION OF THE DRAWINGS

The invention will be described in detail with reference to the attached drawings, in which:

FIGS. 1A and 1B are schematic diagrams of two prior art voltage regulators;

FIG. 2 is a schematic diagram of another prior art voltage regulator;

FIG. 3 is a schematic diagram of a basic embodiment of a voltage regulator in accordance with the invention;

FIG. 4 schematic diagram of an embodiment of the voltage regulator of FIG. 3 illustrated in greater detail;

FIG. 5 is a timing diagram of the step response of the regulator of FIG. 4; and

FIG. 6 is a timing diagram of waveforms of signals of the regulator of FIG. 4 for typical current levels of a FLASH memory device.

### DETAILED DESCRIPTION OF THE PREFERRED EMBODIMENTS

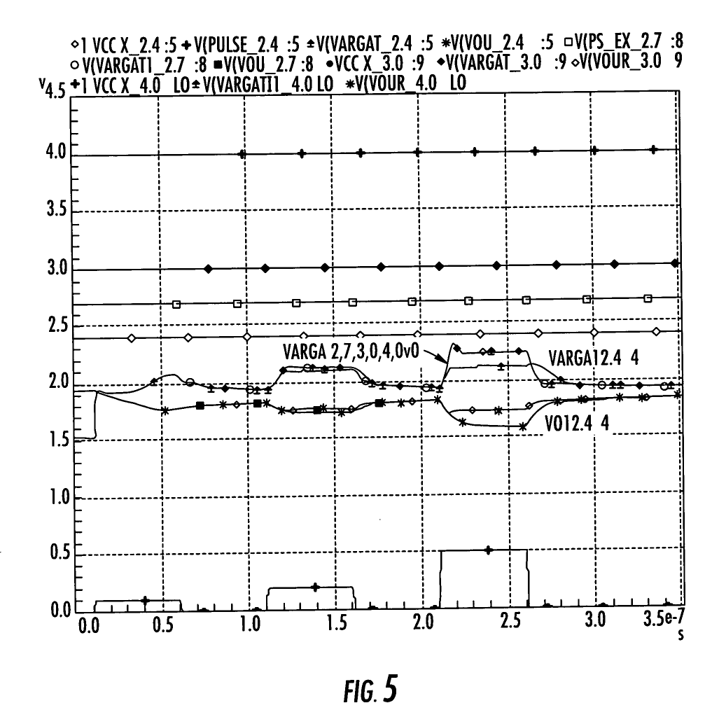

An exemplary architecture of a voltage regulator in accordance with invention is illustrated FIG. 3. For clarity of illustration, the pre-charge and protection circuits of the low-voltage transistors active during a turn on phase have been omitted. Like the prior art regulator illustrated in FIG. 2, the regulator of FIG. 3 has a stage for replicating the output voltage, and the output stage M4 is not included in the control loop that generates the voltage VREF.

With respect to the regulator of FIG. 3, there is a sensing resistor Rs connected in series with the output stage M4, and a voltage drop amplifier VOLTAGE AMPLIFIER has an input connected to the sensing resistor. A reduction of the output voltage VOUT increases the current in the output stage M4, which raises the voltage on the sensing resistor Rs. This voltage variation is amplified by the amplifier VOLTAGE AMPLIFIER that modifies the control voltage of the auxiliary stage M8 to compensate the reduction of the output voltage VOUT.

When the regulator is to be placed in stand-by state, the enable/disable signal EN_N fed to the amplifier VOLTAGE AMPLIFIER sets the latter in a state in which the output control voltage generated is sufficient for turning off the auxiliary stage M8. The presence of a turn on switch for the output stage, which in FIG. 2 is represented by the transistor M9, is no longer required and therefore provides a significant savings in silicon implementation area.

In this case, the power transistor M8 works with a variable gate voltage that may be larger than the voltage VREF that controls the auxiliary stage of the prior art regulator of FIG. 2. The transistor M8 is set in a deeper conduction state when the current required by the load increases, and this reduces significantly its size for the same specifications of average current to be delivered.

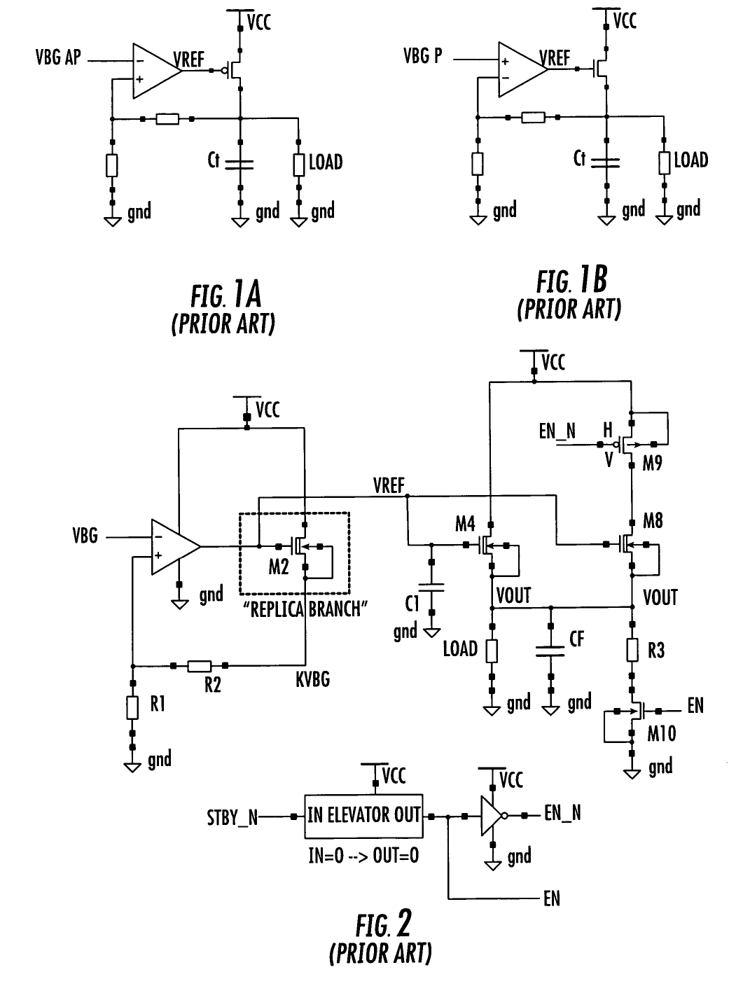

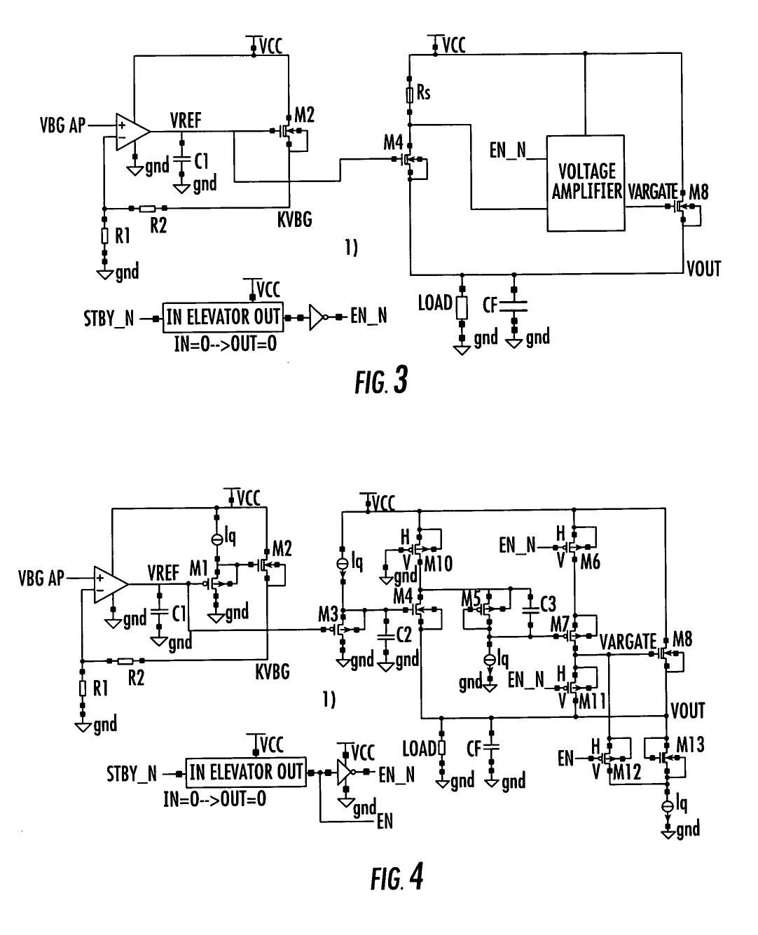

The regulator illustrated in FIG. 3 has an architecture with a relatively small number of stages (i.e., three) to minimize propagation delay. Moreover, the voltage amplifier may be connected to direct the current absorbed by it toward the output node rather than to ground. This may be done by supplying the amplifier between the supply line VCC and the output node. In this way, the power consumption of the regulator is minimized. There is no restriction on the functioning current of the regulator, thus it is easier to obtain a higher response speed than that of the classic feedback regulators of FIGS. 1A and 1B.

By studying the functioning of the regulator shown in FIG. 3 in the frequency domain, the filter capacitor CF on the output node determines the dominating pole while the poles and the zeroes due to the presence of the voltage amplifier VOLTAGE AMPLIFIER are typically located at much higher frequencies (i.e., more than two decades). By choosing the capacitance CF and the loop gain appropriately, these poles and zeroes are confined beyond the cut-off frequency (i.e., the frequency for which the loop gain equals one) and desired stability is provided without the need for further frequency compensations that would reduce the bandwidth.

As a result, the control speed of the gate of the transistor M8 increases and so does the speed response of the output voltage, even if it is limited by the presence of the filter capacitance CF (that is typically on the order of a nF). This makes the output voltage VOUT very stable with a ripple relevantly smaller than that of the above-noted prior art regulators.

Turning now to FIG. 4, and an embodiment of the regulator of FIG. 3 with modifications that provide additional performance improvements and silicon implementation area reduction is now described. The replica stage is configured as a double voltage follower (M1, M2), like the output stage (M3, M4). This allows disturbances induced by fluctuations of the output above the voltage VREF to be minimized because the capacitive coupling is realized through the electrical series of two overlap capacitances relative to transistors M3, M4 that are much smaller than the power transistor M8. Disturbances are also reduced due to the double filtering technique by the capacitors C1, C2 with a total capacitance smaller than that of the case shown in FIG. 3.

The bias currents Iq are on the order of a hundred nA, thus they do not substantially worsen the power consumption in a stand-by state. The voltage amplifier is implemented by the MOS M7 in a common source configuration with a load resistance provided by the transistor M11. The voltage level shifter, which includes the PMOS M5, the capacitor C3 and the current generator Iq, is used for biasing the transistor M7 at the turn on threshold.

The sensing resistance Rs includes the MOS M10 that functions as a VCR (Voltage Controlled Resistance) with control voltage proportional to the external supply voltage VCC. The value of the sensing resistance Rs is set based upon a compromise between two opposing considerations. If it is too small it penalizes the loop gain (thus degrading the precision and the speed of the regulator) in case of a relatively low supply voltage. If it is too large, in case of a relatively high supply voltage, it increases the loop gain and reduces the phase margin causing a “ringing” in the step response and eventually even frequency instability.

The use of a transistor M10 as a VCR allows these the two contrasting requisites to be more easily satisfied, making the resistance inversely proportional to the gate-source voltage, i.e., equal to the supply voltage VCC of the regulator. Depending on the amplitude of the variation range of the voltage VCC, it may be convenient to leave a series resistance connected to the MOSFET M10. With such a “composite” sensing resistance having a fixed part and a (voltage controlled) variable part, performances and frequency stability of the regulator in the whole range of values that may assume the supply voltage may be even more effectively optimized.

The transistor M11 is particularly useful when the load current from a high level becomes abruptly null. In this situation, the voltage VOUT exceeds the value kept in stand-by conditions (an “over-elongation”). The over-elongation is larger the higher the supply voltage VCC is (the gate voltage of the transistor M8 saturates in accordance with high levels), and the larger the resistance of the transistor M11 is (the gate capacitance of the transistor M8 discharges more slowly).

By contrast, a resistance of the transistor M11 that is too small with a relatively low supply voltage VCC implies a premature saturation of the transistor M7 and a limitation of the “driving capability” of the regulator. Given that the transistor M11 works as a VCR, it prevents over-elongations for relatively high supply voltages VCC without penalizing the current characteristics for relatively low supply voltages VCC.

In the preferred embodiment illustrated in FIG. 4, the regulator includes a circuit for turning off the transistor M8 which includes the MOSFETs M12 and M13 biased by the generator Iq. In the stand-by functioning mode the MOS M6 and M11 are turned off and the gate of the transistor M8, through the transistor M12, is brought to a potential smaller than the output threshold which has a quantity approximately equal to the threshold voltage of the natural MOS M13.

The turn off circuit is useful because it may not be sufficient to nullify the gate-source voltage of the natural transistor M8 to nullify its under-threshold current. Indeed, depending on the size of the transistor M8, the under-threshold current may be relevantly larger than the stand-by current, especially at high temperatures. The under-threshold current is added to the current provided by the MOSFET M4 and modifies the DC component of the output voltage VOUT. Making the gate-source voltage of the transistor M8 slightly negative ensures its turning off and eliminates this drawback.

The control circuit that generates the signal enabling/disabling EN_N as a function of an external stand-by command STBY_N will drive only the switch M6, the size of which is much smaller than the size of M9. IN addition to saving silicon implementation area, the delay for resuming the output regulator from a stand-by condition is also reduced.

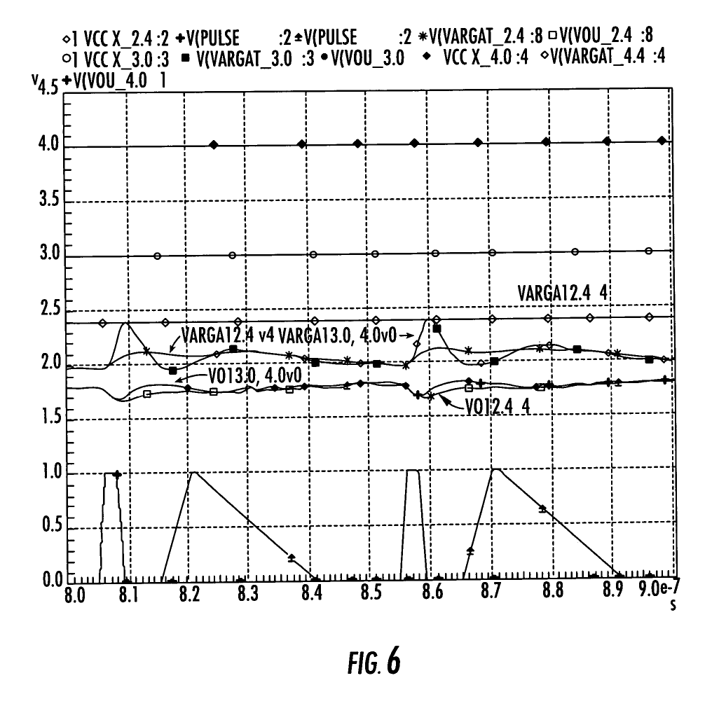

FIGS. 5 and 6 show the main characteristics of the regulator of this regulator of FIG. 4, wherein the transistor M8 has an aspect ratio of 1500 μm/0.64 μm and filter capacitance CF=2 nF. FIG. 5 shows the step response when the load current varies, the external supply voltage VCC being 2.4V, 2.7V, 3.0V and 4.0V. In the simulation, the load is provided by a current generator (not shown in the figure) with constant transconductance controlled by a voltage PULSE1 defined by rectangular pulses of increasing amplitude.

The step response highlights a good speed, both for a decreasing step as well as for an increasing step, with negligible “ringing”, independently from the external supply voltage. It should be noted that the ripple of the output voltage in steady state conditions for external supply voltages larger than 2.7V is significantly reduced because the characteristic of regulation is essentially horizontal.

FIG. 6 shows waveforms of the output voltage for a typical current absorption of a FLASH memory during a reading operation, with external supply voltage VCC at 2.4V, 3.0V and 4.0V. In the simulation the load is provided by two voltage-controlled current generators (not shown). The control voltage PULSE1 controls a generator of a transconductance g1=100 mS, while the control voltage PULSE2 controls a generator of a transconductance g2=25 mS. Even in this case, the ripple of the output voltage is extremely narrow, i.e., within ±100 mV, independent from the external supply voltage.

The voltage regulator of FIG. 4 requires less silicon implementation area, has good regulation and dynamic response characteristics, and has reduced power consumption in a stand-by state and in a normal functioning state. These characteristics allow the compactness and low consumption characteristics offered by the technological “scaling” down progress to be exploited, as well as the speed with which data is retrieved from NOR type FLASH memory devices. Moreover, it may also have the following advantages:

low stand-by state consumption (about 2 μA) within 10% of the typical consumption of a FLASH memory device;

power consumption in working condition is substantially zero, i.e., nearly all the current absorbed by the regulator is delivered to the load;

negligible delay when resuming from a stand-by state, typically in the order of ins, without significant reduction of the speed with which data is retrieved from the memory;

high response speed due to the absence of frequency compensations in the voltage amplifier (the ripple results are to be contained within 100 mV for a typical load current absorbed by a FLASH memory during a read operation);

low output resistance (about 1 Ω) with respect to the size of the output power stage; and

a significant reduction of silicon implementation area occupied by the output power stage, saving about 90% of the silicon area occupied by prior art regulators with the same regulation characteristic and range of variation of the external supply voltage.

1-9. (canceled)

10. A voltage regulator comprising:
an output stage for generating an output voltage on an output node of the voltage regulator, said output stage being controlled by a first control voltage;
an auxiliary stage connected in parallel with said output stage and cooperating therewith to supply a load, said auxiliary stage being controlled by a second control voltage;
a sensing resistor connected in series with said output stage; and
a voltage drop amplifier having an input connected to said sensing resistor and generating the second control voltage.

11. The voltage regulator of claim 10 wherein said voltage drop amplifier has a second input connected to the output node of the voltage regulator.

12. The voltage regulator of claim 10 wherein said voltage drop amplifier has an enabling/disabling input for receiving an enabling/disabling signal.

13. The voltage regulator of claim 12 wherein said voltage drop amplifier comprises:
an active load biased with a bias current and having a first terminal connected to the output node and a second terminal providing a turn off voltage for said auxiliary stage; and
a switch coupled between said auxiliary stage and the turn off voltage and controlled by the enabling/disabling singal.

14. The voltage regulator of claim 10 further comprising:
a replica stage substantially identical to said output stage and controlled by the first control voltage for generating a replica of the output voltage of the voltage regulator; and
an operational amplifier for generating the first control voltage based upon a reference voltage and the replica of the output voltage.

15. The voltage regulator of claim 10 wherein said voltage drop amplifier comprises at least one switch for selectively coupling said voltage drop amplifier to a supply voltage and the output node of the voltage regulator.

16. The voltage regulator of claim 10 wherein said output stage comprises a pair of complementary transistors each configured as a double voltage follower.

17. The voltage regulator of claim 16 further comprising a capacitor having a first terminal connected to said complementary transistors and a second terminal connected to a reference voltage.

18. The voltage regulator of claim 10 wherein said sensing resistor comprises a transistor having a gate connected to a reference voltage.

19. A voltage regulator comprising:
an output stage for generating an output voltage on an output node of the voltage regulator, said output stage being controlled by a first control voltage;
an auxiliary stage connected to said output stage and cooperating therewith to supply a load, said auxiliary stage being controlled by a second control voltage;
a sensing resistor connected to said output stage; and
a voltage drop amplifier having an input connected to said sensing resistor and generating the second control voltage.

20. The voltage regulator of claim 19 wherein said voltage drop amplifier has a second input connected to the output node of the voltage regulator.

21. The voltage regulator of claim 19 wherein said voltage drop amplifier has an enabling/disabling input for receiving an enabling/disabling signal; and wherein said voltage drop amplifier comprises:
an active load biased with a bias current and having a first terminal connected to the output node and a second terminal providing a turn off voltage for said auxiliary stage; and
a switch coupled between said auxiliary stage and the turn off voltage and controlled by the enabling/disabling singal.

22. The voltage regulator of claim 19 further comprising:
a replica stage substantially identical to said output stage and controlled by the first control voltage for generating a replica of the output voltage of the voltage regulator; and
an operational amplifier for generating the first control voltage based upon a reference voltage and the replica of the output voltage.

23. The voltage regulator of claim 19 wherein said output stage comprises a pair of complementary transistors each configured as a double voltage follower; and further comprising a capacitor connected between said complementary transistors and a reference voltage.

24. A method for supplying a load comprising:
generating an output voltage on an output node with an output stage based upon a first control voltage;
connecting a sensing resistor to the output stage;
generating a second control voltage using a voltage drop amplifier having an input connected to the sensing resistor; and
controlling an auxiliary stage with the second control voltage so that the auxiliary stage cooperates with the output stage to supply the load.

25. The method of claim 24 wherein the voltage drop amplifier has a second input connected to the output node of the voltage regulator.

26. The method of claim 24 wherein the voltage drop amplifier has an enabling/disabling input for receiving an enabling/disabling signal; and wherein the voltage drop amplifier comprises:
an active load biased with a bias current and having a first terminal connected to the output node and a second terminal providing a turn off voltage for the auxiliary stage; and
a switch coupled between the auxiliary stage and the turn off voltage and controlled by the enabling/disabling singal.

27. The method of claim 24 further comprising:
generating a replica of the output voltage of the voltage regulator using a replica stage substantially identical to the output stage and controlled by the first control voltage; and
generating the first control voltage based upon a reference voltage and the replica of the output voltage.

28. The method of claim 24 wherein the output stage comprises a pair of complementary transistors each configured as a double voltage follower; and wherein the method further comprises connecting a capacitor between the complementary transistors and a reference voltage.
